(19) United States
(12) Patent Application Publication
(10) Pub. No.: US 2026/0067235 A1
(43) Pub. Date: Mar. 5, 2026

(54) SCHEDULING OF PACKET TRANSMISSION

(71) Applicant: Intel Corporation, Santa Clara, CA (US)

(72) Inventors: Sarig LIVNE, Schanya (IL); Robert HATHAWAY, Fair Haven, NJ (US); Nizan MIRON, Moshav Zippori (IL)

(21) Appl. No.: 19/380,308

(22) Filed: Nov. 5, 2025

(51) Int. Cl. H04L 49/00

(52) U.S. Cl. CPC H04L 49/3063; H04L 49/3027

(57) ABSTRACT

Examples described herein relate to a network interface device comprising a host interface; a direct memory access (DMA) circuitry; a network interface; and circuitry to: based on at least partial processing of packets by a transmit packet processing pipeline, perform reordering of the packets based on associated egress time stamps, wherein the partial processing of the packets by the transmit packet processing pipeline comprises at least packet parsing and provide the packets for egress from a port based on the associated egress time stamps.

### BACKGROUND

Time sensitive applications (e.g., video streaming and telecommunications) pace packet transmissions according to predefined Service Level Agreement (SLA) quality of service (QoS) for bandwidth provisioning and/or jitter limitation. For audio-visual data, the packet transmission scheduling is to achieve a visual and audio quality of user experience, that reduces glitches and freezing at the receiving side. For financial applications, the packet transmission scheduling can cause users to receive updates as simultaneously as possible.

### BRIEF DESCRIPTION OF THE DRAWINGS

FIG. 1 depicts an example system.

FIG. 2 depicts an example operation of packet reordering.

FIG. 3A depicts an example of allocations of packets to non-paced traffic buffers or a time wheel.

FIG. 3B depicts an example of packet transmissions of packets.

FIG. 4 depicts an example process

FIG. 5 depicts an example network interface device.

FIG. 6 depicts a system.

### DETAILED DESCRIPTION

In some cases, a network interface device utilizes a transmit pipeline circuitry to perform scheduling of packet transmissions. The transmit pipeline performs other operations on packets such as packet encapsulation, cryptographic operations (e.g., encryption or decryption), compression operations, decompression operations, packet fragmentation, packet coalescing, or other operations. As a result of temporary congestion, internal cache misses, inter-stage packet recirculation, and packet processing directives applied to various flows, jitter and packet reordering can be introduced by the transmit pipeline. Jitter can be a variable time delay for different packets to traverse the transmit pipeline. Consequently, by introducing variable propagation delay, the transmit pipeline may not provide quality of service (QoS) support for packets. Packet bursts can be introduced in the network that result in connection instability and possible packet drops.

Various examples include a timing wheel (TW) to reorder packets to an initial order set by the transmit pipeline or prior to processing by the transmit pipeline to restore scheduled transmit time ordering of packets. A flow can be assigned to a particular Ethernet Traffic Class, or another differentiator to distinguish flows based on QoS. QoS for a packet can include one or more of: permitted jitter level, priority of flow (e.g., high, medium, low), or other fields. A packet transmit time defined by a scheduler can be specified as a timestamp and the TW can reorder packets based on transmit timestamp values. Packets without an associated transmit time or that are available to be scheduled for transmission after the timestamp passes or before a timestamp is scheduled for transmission can be associated to a queue and packets from the queue can be egressed when egress bandwidth is available or according to priority of packets.

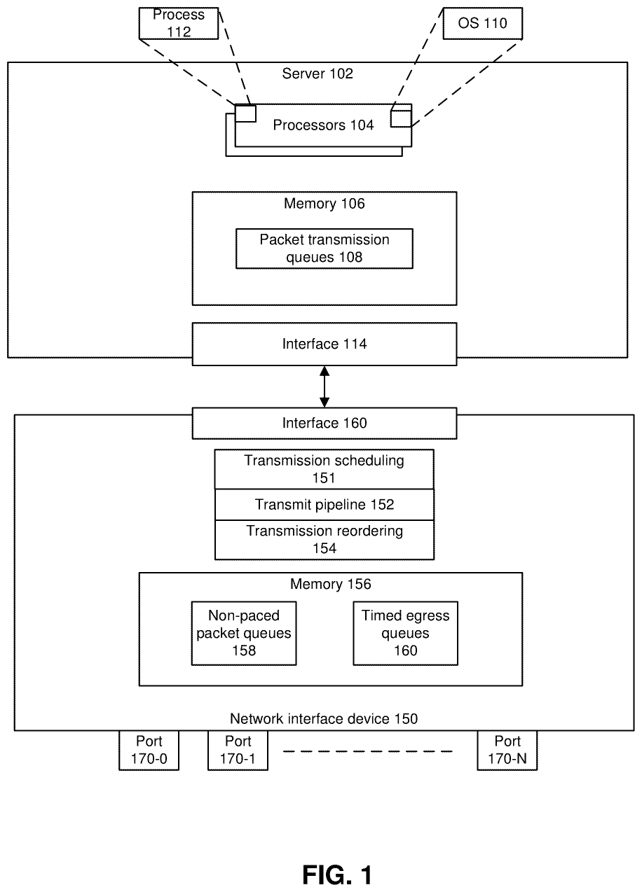

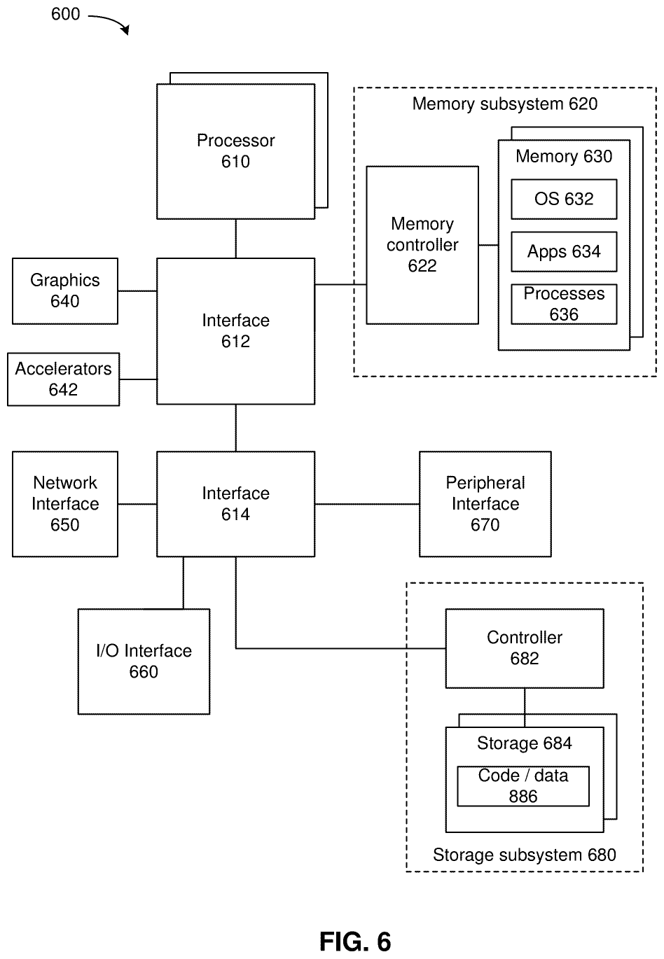

FIG. 1 depicts an example system. Server 102 can include or access one or more processors 104, memory 106, and device interface 114, among other components described herein (e.g., accelerator devices, interconnects, and other circuitry) at least with respect to FIG. 6. Processors 104 can execute processes 112 (e.g., one or more microservices, virtual machines (VMs), containers, or other distributed or virtualized execution environment) that utilize or request transmission of packets using transport technologies such as Transmission Control Protocol (TCP), User Datagram Protocol (UDP), quick UDP Internet Connections (QUIC), RDMA over Converged Ethernet (RoCE), or other protocols.

Processors 104 can execute processes 112 that request transmission of streaming video and audio in a manner consistent with Real-time Transport Protocol (RTP). An example of RTP protocol is described in RFC 3550 (2003). Transmission of streaming video and audio can be consistent with a standard from Society of Motion Picture and Television Engineers (SMPTE) 2110 (2018). Packet formats to map Moving Picture Experts Group (MPEG)-4 (MPEG-4) audio/video into RTP packets is specified at least in RFC 6416 (2011). Video payload formats can include, but are not limited to, H.261, H.263, H.264, H.265, MPEG-1/MPEG-2, or others. Audio payload formats can include, but are not limited to, G.711, G.723, G.726, G.729, MP3, or others. Transmission of streaming video and audio can be consistent with media streaming services such as Dynamic Streaming over HTTP (DASH) protocol or HTTP Live Streaming (HLS). Media can be transmitted using Web Real-Time Communication (WebRTC) or UDP/IP based streaming systems (e.g., Real Time Streaming Protocol (RTSP), quick UDP Internet Connections (QUIC), SMTPE 2022, Session Initiation Protocol (SIP) (RFC 3261 (2020)), ITU Telecommunication Standardization Sector (ITU-T) H.323 (1996), IR.94 (IMS Profile for Conversational Video Service), Jingle (XMPP), etc.). Media can be transmitted using Real-Time Messaging Protocol (RTMP), Secure Reliable Transport (SRT), Transmission Control Protocol (TCP), Microsoft Smooth Streaming (MSS), UDP, or QUIC.

In some examples, one or more processors 104 can request network interface device 150 to transmit one or more packets and utilize packet transmission scheduling and shaping described herein. Network interface device 150 can be implemented as one or more of: a network interface controller (NIC), a remote direct memory access (RDMA)-enabled NIC, SmartNIC, router, switch, forwarding element, infrastructure processing unit (IPU), or data processing unit (DPU). Network interface device 150 can be communicatively coupled to interface 114 of server 102 using interface 160. Interface 114 and interface 160 can communicate based on Peripheral Component Interconnect Express (PCIe), Compute Express Link (CXL). See, for example, Peripheral Component Interconnect Express (PCIe) Base Specification 1.0 (2002), as well as earlier versions, later versions, and variations thereof. See, for example, Compute Express Link (CXL) Specification revision 2.0, version 0.7 (2019), as well as earlier versions, later versions, and variations thereof.

Scheduler 151 can schedule packets for transmission at egress timestamp values. Transmit pipeline 152 can process packets of multiple flows prior to transmission through one or more ports. Transmit pipeline 152 can perform processing of packets of different flows from packet transmission queues 108 such as: packet parsing (parser), cryptographic operations (e.g., encryption or decryption), compression or decompression operations, encapsulation, fragmentation, exact match-action (e.g., small exact match (SEM) engine or a large exact match (LEM)), wildcard match-action (WCM), longest prefix match block (LPM), a hash block, a packet modifier (modifier), or traffic manager (e.g., transmit rate metering or shaping). For example, transmit pipeline 152 can implement access control lists (ACLs) to allow or deny a packet to traverse to an egress port or packet drops due to queue overflow. Configuration of operation of transmit pipeline 152 can be programmed using Programming Protocol-independent Packet Processors (P4), C, Python, Broadcom Network Programming Language (NPL), or x86 compatible executable binaries or other executable binaries. Transmit pipeline 152 can output processed packets of multiple flows out of timestamp order.

A flow can be a sequence of packets being transferred between two endpoints, generally representing a single session using a known protocol. Accordingly, a flow can be identified by a set of defined tuples and, for routing purpose, a flow is identified by the two tuples that identify the endpoints, e.g., the source and destination addresses. For content-based services (e.g., load balancer, firewall, intrusion detection system, etc.), flows can be discriminated at a finer granularity by using N-tuples (e.g., source address, destination address, IP protocol, transport layer source port, and destination port). A packet in a flow is expected to have the same set of tuples in the packet header. A packet flow to be controlled can be identified by a combination of tuples (e.g., Ethernet type field, source and/or destination IP address, source and/or destination User Datagram Protocol (UDP) ports, source/destination TCP ports, or any other header field) and a unique source and destination queue pair (QP) number or identifier. A packet may be used herein to refer to various formatted collections of bits that may be sent across a network, such as Ethernet frames, IP packets, TCP segments, UDP datagrams, etc.

In some examples, for packets that are subject to QoS and transmission timestamps, transmission reordering circuitry 154 can assign packets to transmission time slots in time egress queues 160 for an assigned egress port among egress ports 170-0 to 170-N, where N is an integer. In some examples, for packets that are not subject to QoS or transmission times, transmission reordering circuitry 154 can assign packets to non-paced packet queues 158. In some examples, operating system (OS) 110 can enable or disable transmission reordering 154 to order outgoing packet traffic based on time stamp values for particular flows by use of timed egress queues 160.

Memory 156 can store non-paced packet queues 158 and timed egress queues 160 prior to egress from ports 170-0 to 170-N. Memory 156 can be implemented as a volatile memory device including a cache (e.g., Level 1 (L1), Level 2 (L2), Level 3 (L3), and/or last level cache (LLC)). Note that while memory 156 is shown as part of network interface device 150, memory 156 can be part of server 102 or another device.

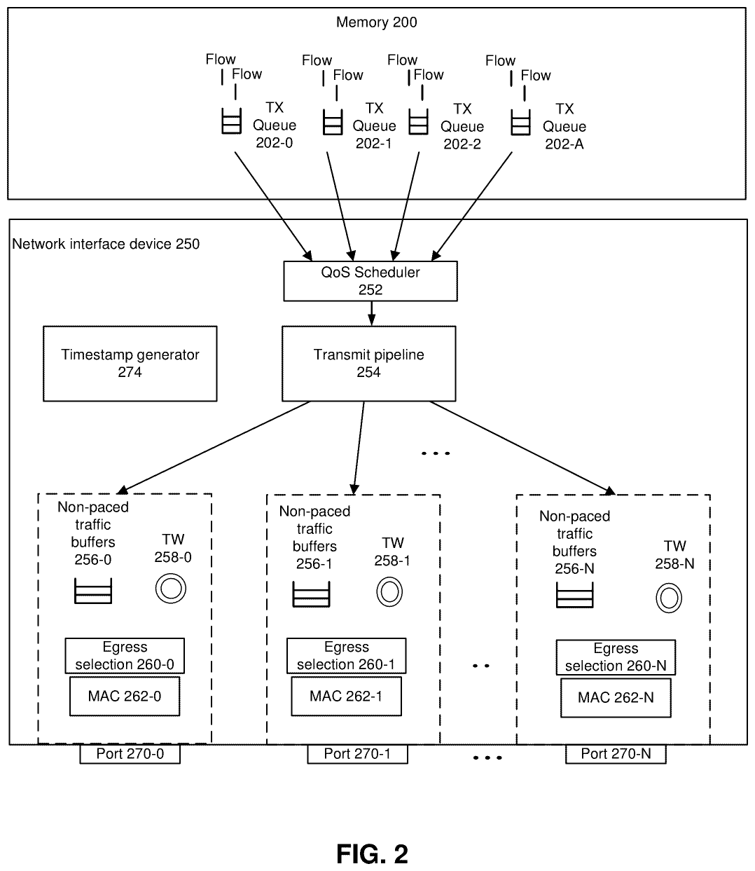

FIG. 2 depicts an example operation of packet reordering. Queues 202-0 to 202-A, where A is an integer, can store descriptors of packets, allocated to one or more different flows, that are to be egressed. For packets that are not subject to egress according to a level of QoS, QoS scheduler 252 can allocate packets for transmission using best efforts. For packets subject to egress according to a level of QoS, Quality of service (QoS) scheduler 252 can set egress or departure timestamps of packets assigned to queues 202-0 to 202-A in memory 200 of a host system. The departure time stamp can be a sum of the timestamp and a configurable time delta for delay through processing by Tx pipeline 254 of the packet. Note that spacing between packet timestamps can represent one or multiple timeslots as some packets may egress over multiple time stamps due to their size. Various transmit scheduling technologies can be utilized such as First-In-First-Out (FIFO), Priority Queuing (PQ), Round Robin, Weighted Round Robin (WRR), or others.

As described herein, packet ordering decisions can be enforced by timing wheels after processing by transmit pipeline 254 whereby traffic is exposed to reordering and jitter due to multiple causes. QoS scheduler 252 can indicate an egress timestamp for a packet in a packet descriptor or metadata. Packet descriptor or metadata can be associated with a packet and stored in a linked list. Metadata information carried through the timing wheel can include one or more of: packet transmission timestamp, port identifier (ID), host identifier (HostID), Traffic Class, Function, virtual server instance (VSI)/virtual machine (VM) identifiers (IDs), cryptography related information (e.g., encryption or decryption key), scatter gather list (SGL) pointers in host memory, information to support flows such as loopback, large segment offloads (LSO), non-volatile memory express (NVMe), remote direct memory access (RDMA) over Converged Ethernet (roce), and so forth.

After QoS scheduler 252 schedules a packet for transmission from a port as either best efforts (non-paced) or subject to QoS or packet transmission time, transmit (Tx) pipeline 254 can process the packet. Various examples of packet processing by Tx pipeline 254 are described herein. Tx pipeline 254 can cause packets of different flows to be output out of timestamp order. In some examples, Tx pipeline 254 can duplicate, enlarge, or shrink packets, which can disturb timing packet transmissions as the packets may utilize more than an allocated timeslot or slots or cause extra packet transmissions.

Depending on an egress port, packets for transmission from a port to be transmitted using best efforts (non-paced) can be allocated first in first out to a corresponding one of non-paced traffic buffers 256-0 to 256-N. Depending on an egress port, packets for transmission from a port and subject to QoS or packet transmission time can be allocated by timestamps to one or more time slots of a corresponding one of TW 258-0 to 258-N.

Per-port timing wheel (TW) 258-0 to 258-N can associate packets with transmit time slots. In some examples, a TW can be allocated to multiple ports. In some examples, packet transmit time slots do not correspond exactly to TW slots and packets can be allocated to a TW slot that is rounded up to a next integer of time stamp value. For example, if a packet transmit slot is 10.5 but the TW slots are allocated on increments of 1, then the packet can be allocated to TW slot 11. Per-port TW 258-0 to 258-N can include a linked list or cyclic buffer that associates one or more packet descriptors for corresponding one or more packets with particular departure times and ordered based on departure timestamps. For example, TW can include an integer M number of slots, where different slots are associated with different nanosecond, microsecond, or other increment of time. A slot can schedule transmission of one or more packets. Note that multiple packets can be slotted for same transmit time slot and in such case, a TW can slot a first arriving packet before a second arriving packet with the same transmit time slot so that the first arriving packet is transmitted near or after its allocated transmit time slot, followed by the second arriving packet.

For ports 270-0 to 270-N, for a timestamp corresponding to a slot in a corresponding TW 262-0 to 262-N, corresponding egress selection circuitry 260-0 to 260-N can egress a packet from the corresponding TW based on time stamp value from time stamp generator 274 and a packet timestamp. The timestamp can represent an earliest departure time of the packet, and can help ensure that packets are not transmitted until a timer value is greater than or equal to a packet's timestamp. Egressing a packet at a time stamp of time slot can restore original packet transmission order and restore packet transmit time order of packets. Packets can be subjected to de-jitter based on traffic class, per-TX queue, or per packet descriptor. In some cases, packets within the same flows are not misordered as they are exposed to the same pipeline actions and therefore, they are enqueued to a TW in the original order.

However, if no packet is associated with a TW slot for the timestamp, egress selection circuitry 260-0 to 260-N can select a packet from a corresponding non-paced traffic buffer 256-0 to 256-N. Non-paced traffic buffers 260-0 to 260-N can store packets not subject to transmission at a particular time stamp or are late arrivals of early arrivals (outside of a TW time window). Late arriving packets can be dropped or slotted into a soonest available time slot that is not associated with a packet that has begun to be transmitted. For example, if a packet P1 has a transmit time stamp of 10 and arrives at a time corresponding to time stamp 12 and packet P2 is slotted to transmit at time stamp 13, if packet P2 has commenced transmission, P1 can be slotted after P2, but if P2 has not commenced transmission, then P1 can be slotted at time stamp 13 and P2 can transmit after P1 at time stamp 14.

Early arriving packets can be dropped or slotted into a latest available time slot within the TW time window. For example, if a TW time window is time stamp 1 to time stamp 20, and packet P22 has a transmit time stamp of 30 and arrives at a time corresponding to time stamp 19, if there is no packet allocated to time stamp slot 20, packet P22 can be allocated to time stamp slot 20.

If the packet transmission process is stalled at a TW of TW 258-0 to 258-N, such as by network flow control or receipt of higher priority traffic, transmissions of packets can be stalled. When packet transmissions resume, packets that are scheduled prior to the current time can be transmitted transmit time slot by transmit time slot as the link is not fully utilized according to the scheduler configuration. To avoid overflow, in systems where packet drop is allowed and/or outdated packets are not relevant, the packets from the oldest slots can be dropped to free space for new packets. In some examples, backpressure mechanisms are used to stall incoming packets. Early arriving packets (packets those that do not have yet an available transmit time slot) can be considered as a symptom of a misconfiguration and discarded or (for debug) posted to the earliest available slot. Late arrival packets (packets whose transmit time slot was already served) can be transmitted with higher priority than the normally paced traffic.

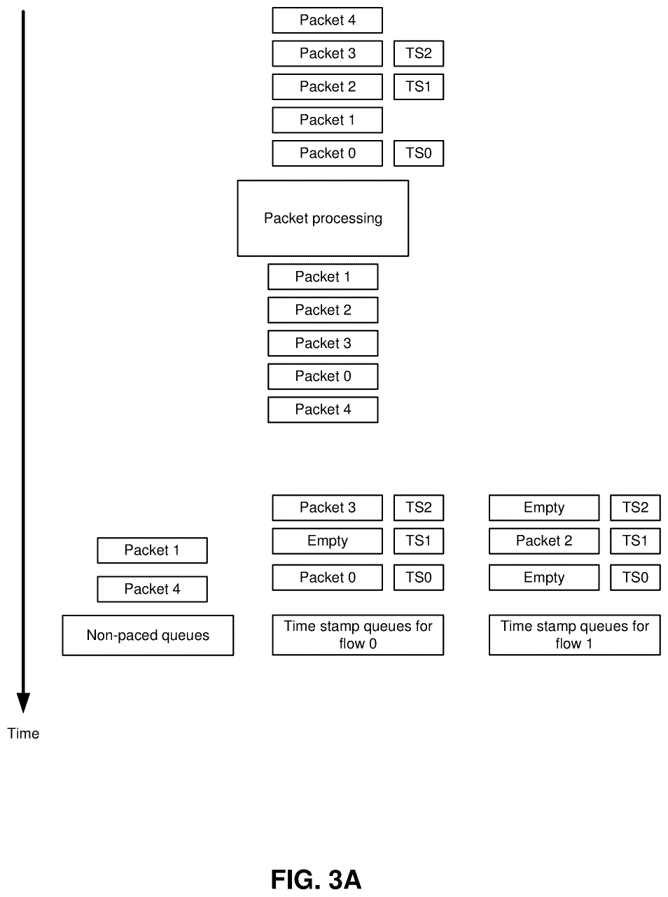

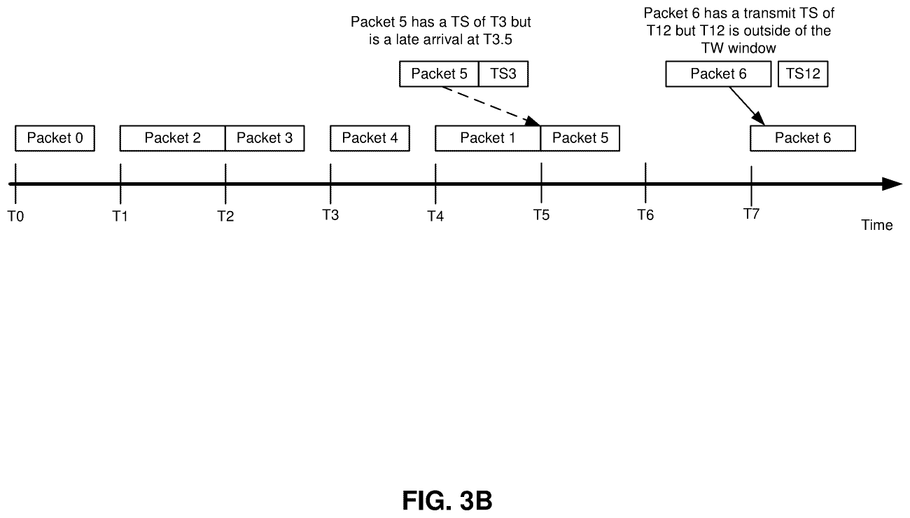

FIG. 3A depicts an example of allocations of packets to non-paced traffic buffers or a time wheel. As shown, after packet processing, packets are provided out of order. In this example, packets 0 and 3 are associated with flow 0 and are assigned respective transmit time stamps TS0 and TS3. Packet 2 is associated with flow 1 and is assigned transmit time stamp TS2. Timeslots TS1 for flow 0 and timestamps 0 and 2 for flow 1 are unassigned. Packets 1 and 4 are not associated with transmit time stamps or flow 0 or 1 and are assigned to non-paced queues. Egress of packets can proceed in the following order: packet 0, packet 2, packet 3, packet 4, and packet 1.

FIG. 3B depicts an example of packet transmissions of packets 0-4 from the prior example and an early arriving and late arriving packet. Packets 0, 2, and 3 are transmitted at respective time stamp values 0, 1, and 2. Non-paced packets, packets 4 and 1 are transmitted at respective time stamp values 3 and 4. Packet 5 was assigned time stamp 3 but is received after time stamp 3 passes (at time stamp between 3 and 4) and is either dropped or egressed at T5, a next available time slot or allocated to time slot T4 if packet 1 has not commenced egressing and packet 1 is assigned time slot T5. Packet 6 was assigned time stamp 12 but the time stamp window is from T0 to T7 and arrived before a reserved timeslot 12 is available and is assigned to a last time slot of the window, T7.

Note that an amount of payload data or header size transmitted in different packets can be the same or different. In some cases, a packet can be scheduled to transmit over multiple timeslots as a particular amount of data can be egressed during a time slot that depends on the port bandwidth.

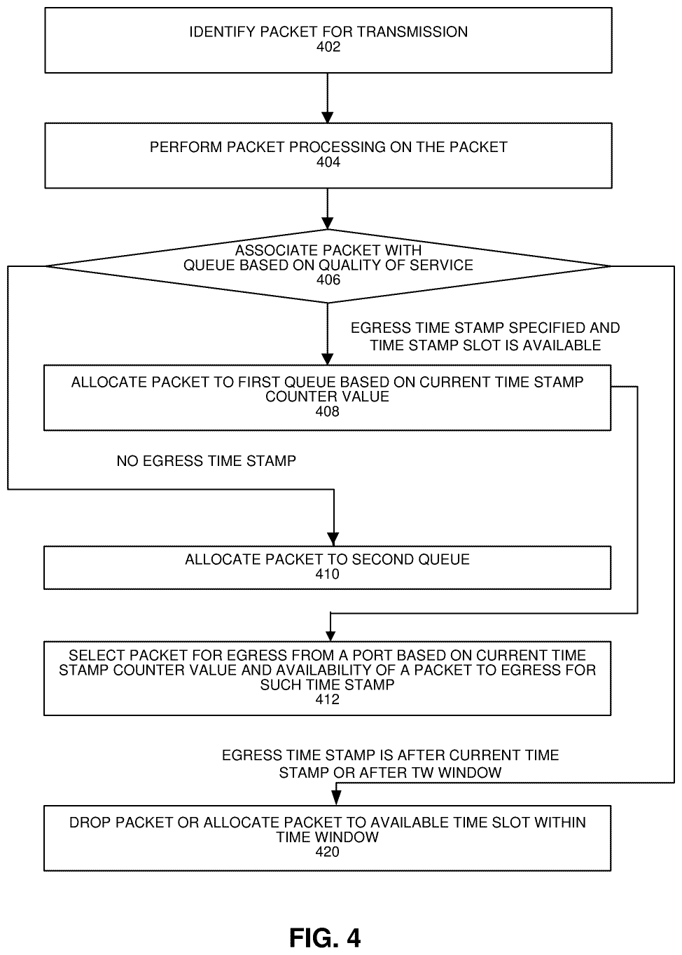

FIG. 4 depicts an example process that can be used to schedule packets for transmission. The process can be used in connection with packet transmission scheduling and shaping. At 402, a packet transmission request can be received. The packet transmission request can have associated descriptor that specifies one or more of: a quality of service (QoS) level, flow identifier, egress port identifier, egress time stamp, or others. At 404, packet processing can occur on the packet prior to transmission. Packet processing can include at least packet encapsulation, cryptographic operations (e.g., encryption or decryption), compression operations, decompression operations, packet fragmentation, packet coalescing, or other operations. At 406, packets can be assigned to queues based at least on whether the packets have associated egress time stamps. At 408, the packet can be assigned to a first queue for the egress port based on the packet having an associated egress time stamp. The first queue can store packets in time order of transmission and queue entries can be associated with particular time stamp values at which packets are to be egressed. At 410, the packet can be assigned to a second queue for the egress port based on the packet not having an associated egress time stamp. At 412, if a packet with an egress time stamp value corresponding to the current time stamp counter value is available in the first queue, the packet can be selected for egressing from the port associated with the first queue. If no packet with an egress time stamp value corresponding to the current time stamp counter value is available in the first queue, a packet from the second queue can be selected for egress from the port associated with the first queue. The process can be performed in parallel for the egress ports.

At 420, based on the packet having an egress time stamp that is after a current time stamp counter value or the packet having an egress time stamp that has not been scheduled for transmission in the first queue, the packet can be dropped or allocated to a time slot for transmission. Based on the packet having an egress time stamp that is after a current time stamp counter value, the packet can be assigned to a closest time slot after the arrival time of the packet, even if a packet is scheduled for transmission in that time slot. Based on the packet having an egress time stamp that is after time window, the packet can be assigned to a last time slot in the time window, even if a packet is scheduled for transmission in that time slot.

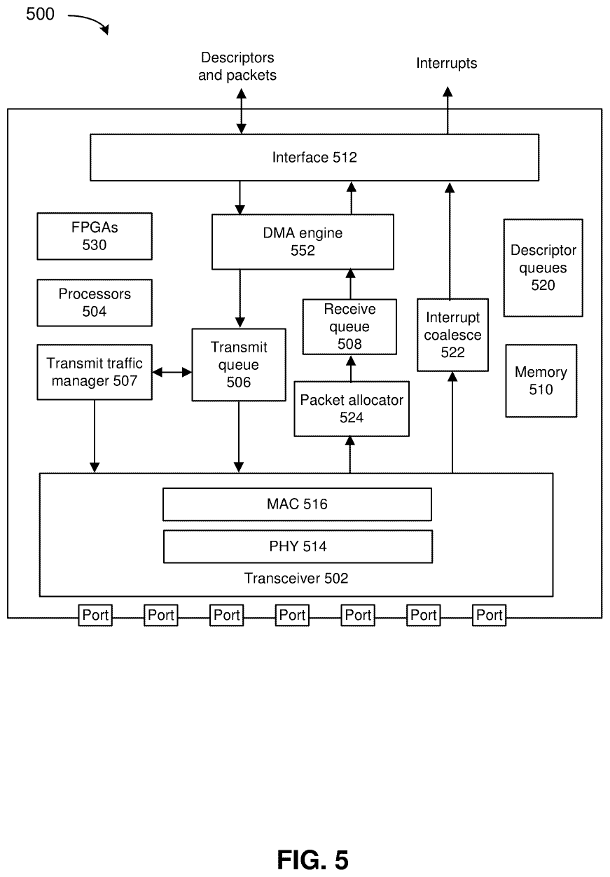

FIG. 5 depicts an example network interface. Various processor resources in the network interface can reorder packets based on egress time stamps after transmit packet processing, as described herein. In some examples, network interface 500 can be implemented as a network interface controller, network interface card, a host fabric interface (HFI), or host bus adapter (HBA), and such examples can be interchangeable. Network interface 500 can be coupled to one or more servers using a bus, PCIe, CXL, or Double Data Rate (DDR). Network interface 500 may be embodied as part of a system-on-a-chip (SoC) that includes one or more processors, or included on a multichip package that also contains one or more processors.

Some examples of network device 500 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 500 can include transceiver 502, processors 504, transmit queue 506, receive queue 508, memory 510, and bus interface 512, and DMA engine 552. Transceiver 502 can be capable of receiving and transmitting packets in conformance with the applicable protocols such as Ethernet as described in IEEE 802.3, although other protocols may be used. Transceiver 802 can receive and transmit packets from and to a network via a network medium (not depicted). Transceiver 502 can include PHY circuitry 514 and media access control (MAC) circuitry 516. PHY circuitry 514 can include encoding and decoding circuitry (not shown) to encode and decode data packets according to applicable physical layer specifications or standards. MAC circuitry 516 can be configured to perform MAC address filtering on received packets, process MAC headers of received packets by verifying data integrity, remove preambles and padding, and provide packet content for processing by higher layers. MAC circuitry 516 can be configured to assemble data to be transmitted into packets, that include destination and source addresses along with network control information and error detection hash values.

For packets that are enqueued for transmission in transmit queue 506, transmit traffic manager 507 can reorder packets for egress based on egress time stamp values after transmit packet pipeline processing, as described herein.

Processors 504 can be any combination of: a processor, core, graphics processing unit (GPU), field programmable gate array (FPGA), application specific integrated circuit (ASIC), or other programmable hardware device that allow programming of network interface 500. For example, a “smart network interface” or SmartNIC can provide packet processing capabilities in the network interface using processors 504.

Processors 504 can include a programmable processing pipeline that is programmable by P4, C, Python, Broadcom Network Programming Language (NPL), or x86 compatible executable binaries or other executable binaries. A programmable processing pipeline can include one or more match-action units (MAUs) that can reorder packets based on egress time stamps after transmit packet processing, as described herein. Processors, FPGAs, other specialized processors, controllers, devices, and/or circuits can be utilized for packet processing or packet modification. Ternary content-addressable memory (TCAM) can be used for parallel match-action or look-up operations on packet header content.

Packet allocator 524 can provide distribution of received packets for processing by multiple CPUs or cores using receive side scaling (RSS). When packet allocator 524 uses RSS, packet allocator 524 can calculate a hash or make another determination based on contents of a received packet to determine which CPU or core is to process a packet.

Interrupt coalesce 522 can perform interrupt moderation whereby network interface interrupt coalesce 522 waits for multiple packets to arrive, or for a time-out to expire, before generating an interrupt to host system to process received packet(s). Receive Segment Coalescing (RSC) can be performed by network interface 500 whereby portions of incoming packets are combined into segments of a packet. Network interface 500 provides this coalesced packet to an application.

Direct memory access (DMA) engine 552 can copy a packet header, packet payload, and/or descriptor directly from host memory to the network interface or vice versa, instead of copying the packet to an intermediate buffer at the host and then using another copy operation from the intermediate buffer to the destination buffer.

Memory 510 can be any type of volatile or non-volatile memory device and can store any queue or instructions used to program network interface 500. Transmit queue 506 can include data or references to data for transmission by network interface. Receive queue 508 can include data or references to data that was received by network interface from a network. Descriptor queues 520 can include descriptors that reference data or packets in transmit queue 506 or receive queue 508. Bus interface 512 can provide an interface with host device (not depicted). For example, bus interface 512 can be compatible with or based at least in part on PCI, PCI Express, PCI-x, Serial ATA, and/or USB (although other interconnection standards may be used), or proprietary variations thereof.

FIG. 6 depicts an example computing system. Components of system 600 (e.g., processor 610, network interface 650, and so forth) to reorder packets for transmission based on egress time stamps after transmit packet pipeline processing, as described herein. System 600 includes processor 610, which provides processing, operation management, and execution of instructions for system 600. Processor 610 can include any type of microprocessor, central processing unit (CPU), graphics processing unit (GPU), processing core, or other processing hardware to provide processing for system 600, or a combination of processors. Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In some examples, system 600 includes interface 612 coupled to processor 610, which can represent a higher speed interface or a high throughput interface for system components that needs higher bandwidth connections, such as memory subsystem 620 or graphics interface components 640, or accelerators 642. Interface 612 represents an interface circuit, which can be a standalone component or integrated onto a processor die. Where present, graphics interface 640 interfaces to graphics components for providing a visual display to a user of system 600. In some examples, graphics interface 640 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In some examples, the display can include a touchscreen display. In some examples, graphics interface 640 generates a display based on data stored in memory 630 or based on operations executed by processor 610 or both. In some examples, graphics interface 640 generates a display based on data stored in memory 630 or based on operations executed by processor 610 or both.

Accelerators 642 can be a fixed function or programmable offload engine that can be accessed or used by a processor 610. For example, an accelerator among accelerators 642 can provide compression (DC) capability, cryptography services such as public key encryption (PKE), cipher, hash/authentication capabilities, decryption, or other capabilities or services. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 642 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In some examples, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

In some examples, OS 632 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others. In some examples, a driver can configure network interface 650 to reorder packets based on egress time stamps after transmit packet processing, as described herein. A driver can advertise capability of network interface 650 to reorder packets based on egress time stamps after transmit packet processing, as described herein.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In some examples, system 600 includes interface 614, which can be coupled to interface 612. In some examples, interface 614 represents an interface circuit, which can include standalone components and integrated circuitry. In some examples, multiple user interface components or peripheral components, or both, couple to interface 614. Network interface 650 provides system 600 the ability to communicate with remote devices (e.g., servers or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory.

Some examples of network interface 650 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

In some examples, system 600 includes one or more input/output (I/O) interface(s) 660. I/O interface 660 can include one or more interface components through which a user interacts with system 600 (e.g., audio, alphanumeric, tactile/touch, or other interfacing). Peripheral interface 670 can include any hardware interface not specifically mentioned above. Peripherals refer generally to devices that connect dependently to system 600. A dependent connection is one where system 600 provides the software platform or hardware platform or both on which operation executes, and with which a user interacts.

In some examples, system 600 includes storage subsystem 680 to store data in a nonvolatile manner. In some examples, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600) or non-volatile memory (e.g., a memory whose state is determinate even if power is interrupted to the device). In some examples, storage subsystem 680 includes controller 682 to interface with storage 684. In some examples, controller 682 is a physical part of interface 614 or processor 610 or can include circuits or logic in both processor 610 and interface 614.

In an example, system 600 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card. ” Accordingly, each blade includes components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, fog network elements, and/or hybrid data centers (e.g., data center that use virtualization, cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An embodiment of the devices, systems, and methods may include any one or more, and any combination of, the examples described below.
Example 1 includes one or more examples, and includes an apparatus that includes: a network interface device comprising: a host interface; a direct memory access (DMA) circuitry; a network interface; and circuitry to: based on at least partial processing of packets by a transmit packet processing pipeline, perform reordering of the packets based on associated egress time stamps, wherein the partial processing of the packets by the transmit packet processing pipeline comprises at least packet parsing and provide the packets for egress from a port based on the associated egress time stamps.
Example 2 includes one or more prior or later examples, wherein the transmit packet processing pipeline provides the packets out-of-time stamp order.
Example 3 includes one or more prior or later examples, wherein the circuitry is to: allocate packets without associated egress time stamps to a queue for egress based on available time stamp slots.
Example 4 includes one or more prior or later examples, wherein the circuitry is to: allocate a first packet of the packets to the queue based on the first packet having an associated egress time stamp that is after a then-current time stamp value and allocate a second packet of the packets to the queue based on the second packet having an associated egress time stamp that does not have an allocated time stamp slot.
Example 5 includes one or more prior or later examples, wherein the circuitry is to allocate the packets to a timing wheel to perform reordering of the packets based on associated egress time stamps.
Example 6 includes one or more prior or later examples, wherein the transmit packet processing circuitry is to perform one or more of: packet parsing, exact match-action, wildcard match-action (WCM), longest prefix match block (LPM), a packet modifier, transmit rate metering or shaping, cryptographic operations, compression or decompression operations, or access control list (ACL).
Example 7 includes one or more prior or later examples, wherein the network interface device comprises one or more of: network interface controller (NIC), a remote direct memory access (RDMA)-enabled NIC, SmartNIC, router, switch, forwarding element, infrastructure processing unit (IPU), or data processing unit (DPU).
Example 8 includes one or more prior or later examples, and at least one non-transitory computer-readable medium comprising instructions stored thereon, that if executed by one or more processors, cause the one or more processors to: execute an operating system (OS) to configure a network interface device to: based on at least partial processing of packets by a transmit packet processing pipeline, allocate multiple packets of the packets to a first queue based on the multiple packets having associated egress time stamps to reorder the multiple packets based on order of egress time stamps, wherein the partial processing of the packets by the transmit packet processing pipeline comprises packet parsing and provide the multiple packets for egress from a port from the first queue based on the associated egress time stamps.
Example 9 includes one or more prior or later examples, wherein the OS is to advertise capability for the network interface device to reorder packets based on associated egress time stamps and to configure the network interface device to reorder packets based on associated egress time stamps based on a request.
Example 10 includes one or more prior or later examples, wherein the packet processing pipeline provides at least one of the multiple packets out-of-time stamp order.
Example 11 includes one or more prior or later examples, comprising instructions stored thereon, that if executed by one or more processors, cause the one or more processors to: execute the OS to configure the network interface device to: allocate second multiple packets of the packets without associated egress time stamps to a second queue for egress based on available time stamp slots.
Example 12 includes one or more prior or later examples, comprising instructions stored thereon, that if executed by one or more processors, cause the one or more processors to: execute the OS to configure the network interface device to: allocate a second packet of the packets to the second queue based on the second packet having an associated egress time stamp that is after a then-current time stamp value.
Example 13 includes one or more prior or later examples, comprising instructions stored thereon, that if executed by one or more processors, cause the one or more processors to: execute the OS to configure the network interface device to: allocate a second packet of the packets to the second queue based on the second packet having an associated egress time stamp that does not have an allocated time stamp slot.
Example 14 includes one or more prior or later examples, wherein the processing of the packets by a packet processing pipeline is to perform one or more of: packet parsing, exact match-action, wildcard match-action (WCM), longest prefix match block (LPM), a packet modifier, transmit rate metering or shaping, cryptographic operations, compression or decompression operations, or access control list (ACL).
Example 15 includes one or more prior or later examples, wherein the network interface device comprises one or more of: network interface controller (NIC), a remote direct memory access (RDMA)-enabled NIC, SmartNIC, router, switch, forwarding element, infrastructure processing unit (IPU), or data processing unit (DPU).
Example 16 includes one or more prior or later examples, and includes a method comprising: managing transmission of packets at transmission times by: based on at least partial processing of the packets by a transmit packet processing pipeline of a network interface device, assigning multiple packets of the packets to a first queue based on the multiple packets having associated egress time stamps to reorder the multiple packets based on order of egress time stamps, wherein the partial processing of the packets by the transmit packet processing pipeline comprises packet parsing and providing the multiple packets for egress from a port from the first queue based on the associated egress time stamps.
Example 17 includes one or more prior or later examples, wherein the packet processing pipeline provides at least one of the multiple packets out-of-time stamp order.
Example 18 includes one or more prior or later examples, and includes allocating a second multiple packets of the packets without associated egress time stamps to a second queue for egress based on available time stamp slots.
Example 19 includes one or more prior or later examples, and includes allocating a second packet of the packets to the second queue based on the second packet having an associated egress time stamp that is after a then-current time stamp value and allocating a third packet of the packets to the second queue based on the third packet having an associated egress time stamp that does not have an allocated time stamp slot.
Example 20 includes one or more prior examples, wherein the processing of the packets by a packet processing pipeline comprises one or more of: packet parsing, exact match-action, wildcard match-action (WCM), longest prefix match block (LPM), a packet modifier, transmit rate metering or shaping, cryptographic operations, compression or decompression operations, or access control list (ACL).

What is claimed is:

1. An apparatus comprising:
a network interface device comprising:
a host interface;
a direct memory access (DMA) circuitry;
a network interface; and
circuitry to:
based on at least partial processing of packets by a transmit packet processing pipeline, perform reordering of the packets based on associated egress time stamps, wherein the partial processing of the packets by the transmit packet processing pipeline comprises at least packet parsing and
provide the packets for egress from a port based on the associated egress time stamps.

2. The apparatus of claim 1, wherein the transmit packet processing pipeline provides the packets out-of-time stamp order.

3. The apparatus of claim 1, wherein the circuitry is to:
allocate packets without associated egress time stamps to a queue for egress based on available time stamp slots.

4. The apparatus of claim 3, wherein the circuitry is to:
allocate a first packet of the packets to the queue based on the first packet having an associated egress time stamp that is after a then-current time stamp value and
allocate a second packet of the packets to the queue based on the second packet having an associated egress time stamp that does not have an allocated time stamp slot.

5. The apparatus of claim 1, wherein the circuitry is to allocate the packets to a timing wheel to perform reordering of the packets based on associated egress time stamps.

6. The apparatus of claim 1, wherein the transmit packet processing circuitry is to perform one or more of: packet parsing, exact match-action, wildcard match-action (WCM), longest prefix match block (LPM), a packet modifier, transmit rate metering or shaping, cryptographic operations, compression or decompression operations, or access control list (ACL).

7. The apparatus of claim 1, wherein the network interface device comprises one or more of: network interface controller (NIC), a remote direct memory access (RDMA)-enabled NIC, SmartNIC, router, switch, forwarding element, infrastructure processing unit (IPU), or data processing unit (DPU).

8. At least one non-transitory computer-readable medium comprising instructions stored thereon, that if executed by one or more processors, cause the one or more processors to:
execute an operating system (OS) to configure a network interface device to:
based on at least partial processing of packets by a transmit packet processing pipeline, allocate multiple packets of the packets to a first queue based on the multiple packets having associated egress time stamps to reorder the multiple packets based on order of egress time stamps, wherein the partial processing of the packets by the transmit packet processing pipeline comprises packet parsing and
provide the multiple packets for egress from a port from the first queue based on the associated egress time stamps.

9. The at least one computer-readable medium of claim 8, wherein the OS is to advertise capability for the network interface device to reorder packets based on associated egress time stamps and to configure the network interface device to reorder packets based on associated egress time stamps based on a request.

10. The at least one computer-readable medium of claim 8, wherein the packet processing pipeline provides at least one of the multiple packets out-of-time stamp order.

11. The at least one computer-readable medium of claim 8, comprising instructions stored thereon, that if executed by one or more processors, cause the one or more processors to:
execute the OS to configure the network interface device to:
allocate second multiple packets of the packets without associated egress time stamps to a second queue for egress based on available time stamp slots.

12. The at least one computer-readable medium of claim 11, comprising instructions stored thereon, that if executed by one or more processors, cause the one or more processors to:
execute the OS to configure the network interface device to:
allocate a second packet of the packets to the second queue based on the second packet having an associated egress time stamp that is after a then-current time stamp value.

13. The at least one computer-readable medium of claim 11, comprising instructions stored thereon, that if executed by one or more processors, cause the one or more processors to:
execute the OS to configure the network interface device to:
allocate a second packet of the packets to the second queue based on the second packet having an associated egress time stamp that does not have an allocated time stamp slot.

14. The at least one computer-readable medium of claim 9, wherein the processing of the packets by a packet processing pipeline is to perform one or more of: packet parsing, exact match-action, wildcard match-action (WCM), longest prefix match block (LPM), a packet modifier, transmit rate metering or shaping, cryptographic operations, compression or decompression operations, or access control list (ACL).

15. The at least one computer-readable medium of claim 9, wherein the network interface device comprises one or more of: network interface controller (NIC), a remote direct memory access (RDMA)-enabled NIC, SmartNIC, router, switch, forwarding element, infrastructure processing unit (IPU), or data processing unit (DPU).

16. A method comprising:
managing transmission of packets at transmission times by:
based on at least partial processing of the packets by a transmit packet processing pipeline of a network interface device, assigning multiple packets of the packets to a first queue based on the multiple packets having associated egress time stamps to reorder the multiple packets based on order of egress time stamps, wherein the partial processing of the packets by the transmit packet processing pipeline comprises packet parsing and
providing the multiple packets for egress from a port from the first queue based on the associated egress time stamps.

17. The method of claim 16, wherein the packet processing pipeline provides at least one of the multiple packets out-of-time stamp order.

18. The method of claim 16, comprising:
allocating a second multiple packets of the packets without associated egress time stamps to a second queue for egress based on available time stamp slots.

19. The method of claim 18, comprising:
allocating a second packet of the packets to the second queue based on the second packet having an associated egress time stamp that is after a then-current time stamp value and
allocating a third packet of the packets to the second queue based on the third packet having an associated egress time stamp that does not have an allocated time stamp slot.

20. The method of claim 18, wherein the processing of the packets by a packet processing pipeline comprises one or more of: packet parsing, exact match-action, wildcard match-action (WCM), longest prefix match block (LPM), a packet modifier, transmit rate metering or shaping, cryptographic operations, compression or decompression operations, or access control list (ACL).
